(19) United States
(12) Patent Application Publication
(10) Pub. No.: US 2026/0364800 A1
(43) Pub. Date: Nov. 19, 2026

(54) ROBOT SYSTEM

(71) Applicant: KAWASAKI JUKOGYO KABUSHIKI KASHA, Kobe-shi, Hyogo (JP)

(72) Inventors: Masayuki WATANABE, Kobe-shi (JP); Tomoki SAKUMA, Kobe-shi (JP); Hiroki TAKAHASHI, Kobe-shi (JP); Hiroki KINOSHITA, Kobe-shi (JP); Keizo WATAKABE, Kobe-shi (JP); Hiroki TANAKA, Kobe-shi (JP); Kai SHIMIZU, Kobe-shi (JP)

(73) Assignee: KAWASAKI JUKOGYO KABUSHIKI KASHA, Kobe-shi, Hyogo (JP)

(21) Appl. No.: 19/144,172

(22) PCT Filed: Dec. 22, 2023
(86) PCT No.: PCT/JP2023/046123

§ 371 Date: Jun. 27, 2025

(30) Foreign Application Priority Data
Dec. 27, 2022 (JP) 2022-209750

(51) Int. Cl. B25J 9/16; B25J 9/00; B25J 13/02

(52) U.S. Cl. CPC B25J 9/1682; B25J 9/0087; B25J 9/1633; B25J 9/1664; B25J 9/1671; B25J 13/02

(57) ABSTRACT

A robot system (100) includes a first robot (1), a second robot (2) that performs work in cooperation with the first robot (1); a single manipulator (3) that accepts manipulation from an operator to manipulate the first robot (1) and the second robot (2) ; and a controller (4) that performs control to operate the first robot (1) and the second robot (2) based on the manipulation accepted by the single manipulator (3).

### TECHNICAL FIELD

The present disclosure relates to a robot system.

BACKGROUND ART

Robot systems are known in the art. For example, Japanese Patent Laid-Open Publication No. JP 2005-262369 discloses a robot system including a master robot, a slave robot performing work together with the master robot, and a control apparatus controlling operation of the master robot and the slave robot. In this robot system, the control apparatus controls operation of the master robot based on a program and controls operation of the slave robot to operate in accordance with the operation of master robot.

### PRIOR ART

### Patent Document

Patent Document 1: Japanese Patent Laid-Open Publication No. JP 2005-262369

### SUMMARY OF THE INVENTION

### Problems to be Solved by the Invention

However, in the robot system in the above Japanese Patent Laid-Open Publication No. JP 2005-262369, the control apparatus operates robots including the master robot and the slave robot based on the program. For this reason, in a case where an operator operates robots through an arbitrary manipulation using a manipulator, it is difficult to apply the robot system in the above Japanese Patent Laid-Open Publication No. JP 2005-262369 to the case. Accordingly, it is difficult for the operator to perform work by operating the robots in conjunction with each other through an arbitrary manipulation using the manipulator and such difficulty may cause a problem.

The present disclosure provides a robot system allowing an operator to perform work by operating robots in conjunction with each other through an arbitrary manipulation using a manipulator.

### Means for Solving the Problems

A robot system according to one aspect of the present disclosure includes a first robot; a second robot that performs work in cooperation with the first robot; a single manipulator accepting manipulation from an operator to manipulate the first robot and the second robot; and a controller that performs control to operate the first robot and the second robot based on the manipulation accepted by the single manipulator.

In the robot according to the one aspect of the present disclosure, as discussed above, a controller that performs control to operate the first robot and the second robot based on the manipulation accepted by the single manipulator is provided. Accordingly, the operator can operate the first robot and the second robot in conjunction with each other by manipulating the single manipulator. Consequently, the operator can perform work by operating the robots in conjunction with each other through an arbitrary manipulation using the manipulator. In addition, since the operator can manipulate the robots through the single manipulator, the operator can easily manipulate the robots as compared with a case where the operator individually manipulates the robots through separate manipulators. As a result, since an increase in burden on the operator can be prevented, the operator can perform work through the robots in conjunction with each other.

### Effect of the Invention

According to the present disclosure, as discussed above, operators can perform work by operating robots in conjunction with each other through an arbitrary manipulation using a manipulator.

### BRIEF DESCRIPTION OF THE DRAWINGS

FIG. 1 is a view schematically showing a robot system according to one embodiment.

FIG. 2 is a block diagram showing a control-view configuration of the robot system according to the one embodiment.

FIG. 3 is a view illustrating control of robots in conjunction with each other in the robot system according to the one embodiment.

FIG. 4 is a view illustrating manipulation switching of the robots in the robot system according to the one embodiment.

FIG. 5 is a diagram illustrating a positional relation between two robots controlled in conjunction with each other in the robot system according to the one embodiment.

FIG. 6 is a diagram illustrating a positional relation between three robots controlled in conjunction with each other in the robot system according to the one embodiment.

FIG. 7 is a diagram illustrating a positional relation between four robots controlled in conjunction with each other in the robot system according to the one embodiment.

FIG. 8 is a view illustrating prevention of an overload in conjunction control in the robot system according to the one embodiment.

FIG. 9 is a view illustrating a center to be controlled during the conjunction control in the robot system according to the one embodiment.

FIG. 10 is a view illustrating holding forces during grasping and when releasing in the robot system according to the one embodiment.

FIG. 11 is a view illustrating holding forces before grasping and after the start of grasping in the robot system according to the one embodiment.

FIG. 12 is a view illustrating control for prevention of interference between the robots in the robot system according to the one embodiment.

FIG. 13 is a view illustrating switching between manipulation in a simulation environment and manipulation in an actual environment in the robot system according to the one embodiment.

FIG. 14 is a view schematically showing a screen of an information provider in the robot system according to the one embodiment.

### MODES FOR CARRYING OUT THE INVENTION

The following description will describe one embodiment with reference to the drawings.

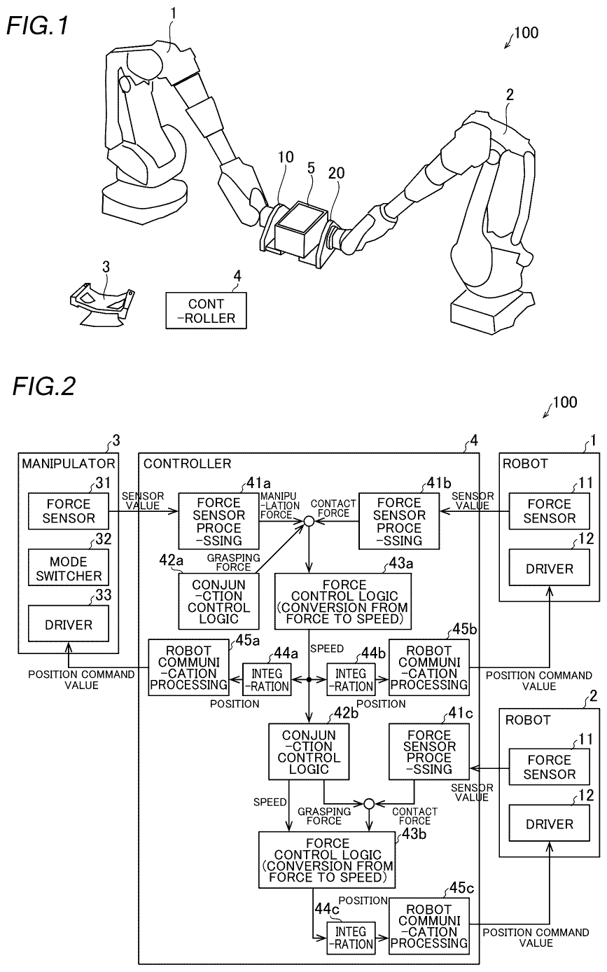

A configuration of a robot system 100 according to this embodiment is described with reference to FIGS. 1 to 14.

As shown in FIG. 1, the robot system 100 include a robot 1, a robot 2, a manipulator 3, and a controller 4. The robots 1 and 2 are, for example, industrial or medical robots. Also, the robots 1 and 2 perform work in cooperation with each other. The robot system 100 perform work on a worked object 5 by using the robots 1 and 2. For example, the robots 1 and 2 hold a worked object 5 by sandwiching the worked object. Here, the robot 1 is an example of a “first robot”, and the robot 2 is an example of a “second robot”.

The robots 1 and 2 have similar configurations. The robots 1 and 2 include vertical multi-joint arms each of which includes six joints. The robot 1 has one distal end to which an end effector 10 is attached. The robot 2 has one distal end to which an end effector 20 is attached. Also, each of the robots 1 and 2 includes a base arranged on another end and is attached to a floor, wall, pillar or the like.

The robots 1 and 2 include their force sensors 11 and drivers 12, as shown in FIG. 2. The force sensor 11 detects a contact force applied to the robot 1 (2). The force sensor 11 includes at least one of a sensor that directly detects a force applied to the robot 1 (2) or a torque sensor that detects a torque of the driver 12. A sensor value detected by the force sensor 11 is transmitted to the controller 4. The driver 12 rotates joints of the robot 1 (2) to operate the robot 1 (2). Specifically, the driver 12 includes electric motors that rotate and drive the joints, and detectors that detect rotational positions of the joints. The driver 12 is driven based on position command values from the controller 4.

The manipulator 3 accepts manipulation from an operator to manipulate the robots 1 and 2. In the robot system 100, a single manipulator 3 is provided for the robots. In other words, the single manipulator 3 can manipulate both the robots 1 and 2. The manipulator 3 accepts manipulation performed by the operator, for example, by moving the manipulator while grasping it with both hands. The manipulator 3 includes a force sensor 31, a mode switcher 32 and a driver 33, as shown in FIG. 2. The force sensor 31 detects a manipulation force applied to the manipulator 3 by manipulation of the operator. The force sensor 31 includes at least one of a sensor that directly detects force applied to the manipulator 3 or a torque sensor that detects torque of the driver 33. A sensor value detected by the force sensor 31 is transmitted to the controller 4. The mode switcher 32 accepts manipulation to switch the robot(s) to be manipulated by the manipulator 3. The driver 33 drives the manipulator 3. Specifically, the driver 33 includes electric motors that rotate and drive the manipulator 3 about axes, and detectors that detect rotational positions about the axes. The driver 33 is driven based on position command values from the controller 4.

Here, in this embodiment, the controller 4 performs control to operate the robots 1 and 2 based on the manipulation accepted by the single manipulator 3. Specifically, the controller 4 includes a CPU (central processing unit) and a memory.

Also, the controller 4 performs control, based on the manipulation by the single manipulator 3, to operate the robot 1 and to operate the robot 2 to follow operation of the robot 1. Accordingly, since the robot 1 can be operated to operate the robot 2 to follow operation of the robot 1 through manipulation by the single manipulator 3, the robot 1 and the robot 2 can be easily operated in conjunction with each other.

Specifically, as shown in FIG. 2, the controller 4 accepts a sensor value based on the manipulation force detected by the force sensor 31 of the manipulator 3 through force sensor processing 41a. Also, the controller 4 accepts the sensor value based on the contact force detected by the force sensor 11 of the robot 1 through force sensor processing 41b. Subsequently, the controller 4 converts a force that is obtained by adding the manipulation force accepted by the force sensor processing 41a, the contact force accepted by the force sensor processing 41b and a grasping force set in conjunction control logic 42a into a moving speed of the robot 1 through force control logic 43a.

The moving speed of the robot 1 is integrated through integration 44a to calculate a position value. The calculated position value is transmitted as a position command value to the driver 33 of the manipulator 3 through robot communication processing 45a. Correspondingly, the manipulator 3 is driven.

Also, the moving speed of the robot 1 is integrated through integration 44b to calculate a position value. The calculated position value is transmitted as a position command value to the driver 12 of the robot 1 through robot communication processing 45b. Correspondingly, the robot 1 is driven.

Also, the controller 4 accepts the sensor value based on the contact force detected by the force sensor 11 of the robot 2 through force sensor processing 41c. Subsequently, the controller 4 converts a force that is obtained by adding the contact force accepted by the force sensor processing 41c and a grasping force set in conjunction control logic 42b into a moving speed of the robot 2 through force control logic 43a, taking into account the moving speed of the robot 1 through the conjunction control logic 42b.

The moving speed of the robot 2 is integrated through integration 44c to calculate a position value. The calculated position value is transmitted as a position command value to the driver 12 of the robot 2 through robot communication processing 45c. Correspondingly, the robot 2 is driven.

In other words, the controller 4 performs control, based on the manipulation by the single manipulator 3, to operate the robot 1 and to operate the robot 2 based on the moving speed of the robot 1. Accordingly, the robot 2 can be controlled to move in accordance with the moving speed of the robot 1.

Also, the controller 4 performs control, when the worked object 5 as a work target is held by using the robots 1 and 2 sandwiching the worked object, to operate the robots 1 and 2 based on the manipulation through the single manipulator 3 to apply predetermined holding forces to the worked object 5. Accordingly, since the holding forces can be constantly applied while the worked object 5 is held by the robots 1 and 2 sandwiching the worked object, the worked object 5 can be reliably held.

Also, the controller 4 performs control to operate the robots 1 and 2 based on the manipulation force of the manipulation from the operator accepted by the manipulator 3, the contact forces applied to the robots 1 and 2, and the holding forces holding the worked object 5 by using the robots 1 and 2. Accordingly, the robot 1 and the robot 2 can be moved in conjunction with each other to keep the manipulation force, the contact forces and the holding forces in balance.

Specifically, the controller 4 performs control to operate the robots 1 and 2 based on the manipulation through the single manipulator 3 to hold the worked object 5 by using the robots 1 and 2 sandwiching the worked object 5. Accordingly, work can be performed on the worked object 5 while the worked object 5 is held by using the robots 1 and 2 sandwiching the worked object.

Also, the controller 4 determines a moving speed of the robot 1 based on the manipulation force of the manipulation from the operator is accepted by the manipulator 3, the contact force applied to the robot 1 and the holding forces holding the worked object 5. In addition, the controller 4 determines the moving speed of the robot 2 based on the moving speed of the robot 1, the contact force applied to robot 2, and the holding forces holding the worked object 5. Accordingly, control to move the robot 2 in accordance with the movement of the robot 1 can be easily performed based on the moving speed of the robot 1, the contact force applied to the robot 2 and the holding forces.

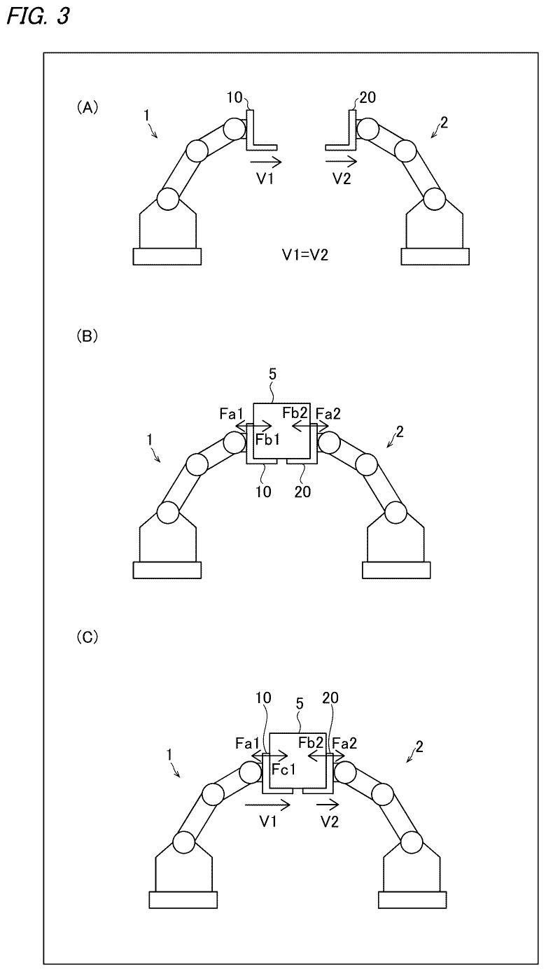

As shown in FIG. 3, the controller 4 operates the robots 1 and 2 while bringing the robots 1 and 2 together to work in conjunction with each other, depending on work to be performed on the worked object 5. As shown in FIG. 3(A), in a case where the worked object 5 is not held by the robots 1 and 2, the robots 1 and 2 are operated at the same speed. For example, the moving speed of the robot 1 is defined as V1, and the moving speed of the robot 2 is defined as V2. In this case, the robots 1 and 2 are operated at V1=V2.

As shown in FIG. 3(B), in a case where the worked object 5 is not held by the robots 1 and 2, the controller 4 performs control to operate the robots 1 and 2 to apply predetermined holding forces Fb1 and Fb2. Also, in this case, the contact force on robot 1 is Fa1, and the contact force to robot 2 is Fa2.

As shown in FIG. 3(C), in a case where the worked object 5 is conveyed while being held by the robots 1 and 2, the controller 4 performs control to operate the robots 1 and 2 to move the worked object 5 based on the manipulation force Fc1 on the manipulator 3. In this conveyance, since the predetermined holding force Fb2 is applied to the worked object 5, the operator can move the worked object 5 without consciously holding the worked object 5. Also, in this case, the robot 1 moves at a speed V1, and the robot 2 moves at a speed V2 that is smaller the speed than V1. Accordingly, the predetermined holding force Fb2 is applied to the worked object 5.

The robot system 100 can switch between a first mode in which the robot 1 is solely operated by manipulation of the manipulator 3, a second mode in which the robot 2 is solely operated by manipulation of the manipulator 3, and a third mode in which robots 1 and 2 are operated in conjunction with each other by manipulation of the manipulator 3. Accordingly, each of the robots 1 and 2 can be solely operated to be positioned at a desired position, and the robots 1 and 2 can be operated in conjunction with each other.

The controller 4 accepts switching between the first mode, the second mode and the third mode when the mode switcher 32 (see FIG. 2) of the manipulator 3 is manipulated by the operator.

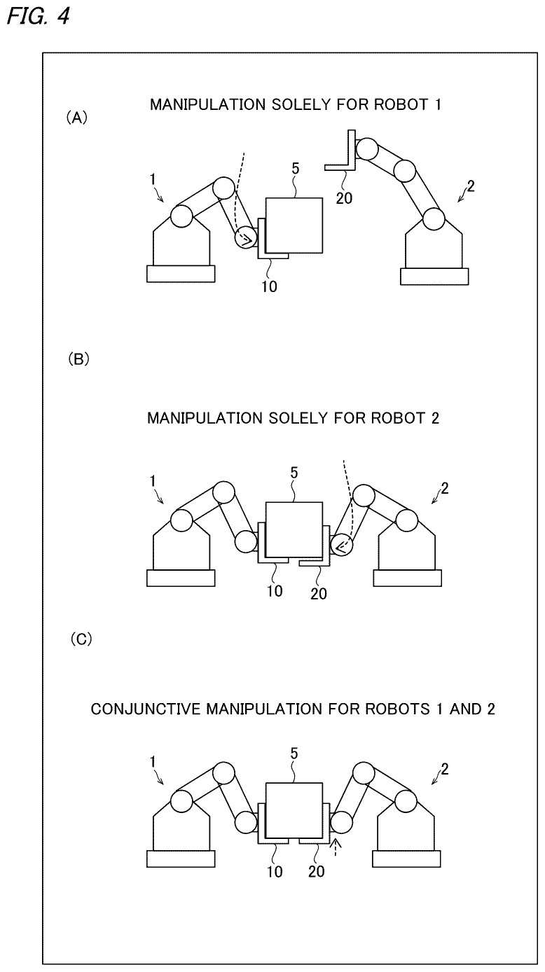

As shown in FIG. 4(A), in the first mode in which the robot 1 is solely operated, the robot 1 is operated by manipulation of the manipulator 3. In this case, the robot 2 does not operate. For example, the robot 1 is moved in proximity to the worked object 5 by manipulation of the manipulator 3. As shown in FIG. 4(B), in the second mode in which the robot 2 is solely operated, the robot 2 is operated by manipulation of the manipulator 3. In this case, the robot 1 does not operate. For example, the robot 2 is moved in proximity to the worked object 5 by manipulation of the manipulator 3. In this case, since the robot 2 is moved through the manipulator 3, a height position of the robot 2 may be deviated with respect to a height position of the robot 1. As shown in FIG. 4(C), in the third mode in which the robots 1 and 2 are operated in conjunction with each other, the robots 1 and 2 are operated by manipulation of the manipulator 3. When the system shifts to the third mode, the robots 1 and 2 are operated in conjunction with each other so that the position and posture of the robot 2 align with the position and posture of the robot 1. For example, the robot 2 moves so that the height position of the robot 2 agrees with the height position of the robot 1.

The position of the robot 2 operating in conjunction with the robot 1 is set relative to the robot 1 as a reference. Specifically, the position of the robot 2 operating in conjunction with the robot 1 as viewed in a plan view is set to a position PB relative to a position PA of the robot 1 as the reference as shown in FIG. 5 based on dimensions of the worked object 5. The height position of the robot 2 is set at the same position as the height position of the robot 1. Here, the position of the robot refers to a position of TCP set as the distal end of the robot.

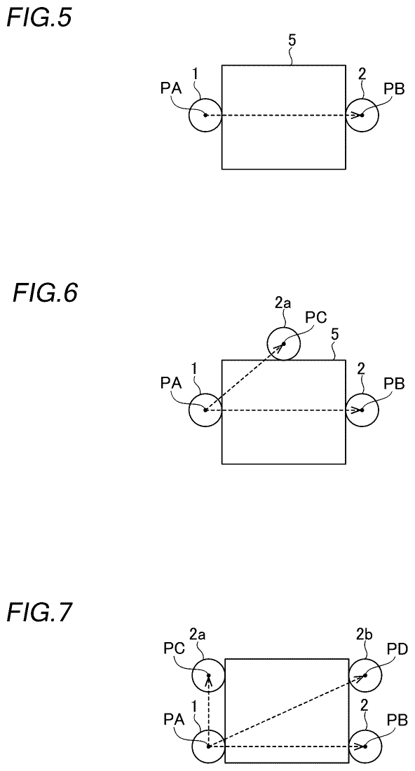

As shown in FIG. 6, in a case of three robots, the positions of robots 2 and 2a operating in conjunction with the robot 1 are set with respect to the robot 1 as the reference. Specifically, the position of the robot 2 operating in conjunction with the robot 1 as viewed in a plan view is set to a position PB relative to a position PA of the robot 1 as the reference based on the dimensions of the worked object 5. The height position of the robot 2 is set at the same position as the height position of the robot 1. A position of the robot 2a operating in conjunction with the robot 1 as viewed in a plan view is set to a position PC relative to the position PA of the robot 1 as the reference based on the dimensions of the worked object 5. The height position of the robot 2a is set at the same position as the height position of the robot 1.

As shown in FIG. 7, in a case of four robots, the positions of robots 2, 2a and 2b operating in conjunction with the robot 1 are set with respect to the robot 1 as the reference. Specifically, the position of the robot 2 operating in conjunction with the robot 1 as viewed in a plan view is set to a position PB relative to a position PA of the robot 1 as the reference based on the dimensions of the worked object 5. The height position of the robot 2 is set at the same position as the height position of the robot 1. A position of the robot 2a operating in conjunction with the robot 1 as viewed in a plan view is set to a position PC relative to the position PA of the robot 1 as the reference based on the dimensions of the worked object 5. The height position of the robot 2a is set at the same position as the height position of the robot 1. A position of the robot 2b operating in conjunction with the robot 1 as viewed in a plan view is set to a position PD relative to the position PA of the robot 1 as the reference based on the dimensions of the worked object 5. The height position of the robot 2b is set at the same position as the height position of the robot 1.

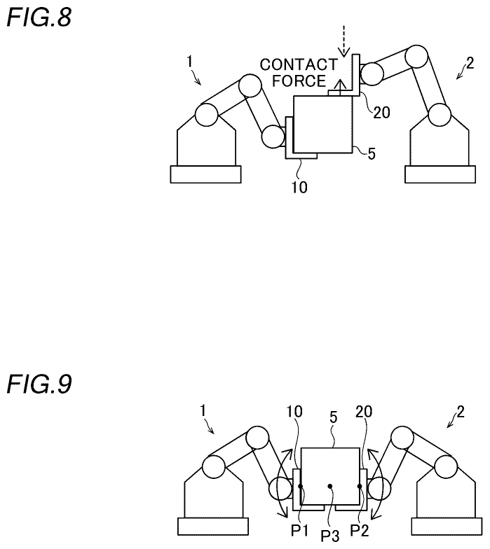

Also, in a case where the position of the robot 2 is moved relative to the position of the robot 1 as the reference, the robot may come in contact with the worked object 5 as shown in FIG. 8. Similar to the robot 1, since moving operation of the robot 2 is controlled while the contact force on the robot 2 is added, the robot 2 is not operated to increase this contact force. Accordingly, it is possible to prevent an overload from being applied to the robot 2.

The controller 4 determines, when the worked object 5 is held by using the robots 1 and 2, control point at which the robots 1 and 2 operate based on the positions of the robots 1 and 2. Accordingly, since the control point can be set at a point that allows the robot 1 and the robot 2 to easily move the worked object 5 being held by the robots based on the positions of the robots, the operator can intuitively perform the operation that moves the worked object 5 by using the robots 1 and 2.

For example, the controller 4 sets a position P3, which is a midpoint between the position P1 of the robot 1 and the position P2 of the robot 2, as the control point serving as a center of rotation.: In other words, since the positions of the robots 1 and 2 are moved as the robots moves, the control point, which serve as the center of rotation, are calculated when necessary. When the worked object 5 is held by the robots 1 and 2, the control point (TCP) of the robot 1 and the control point (TCP) of the robot 2 is to be set at an identical position P3. Here, in a case of three or more robots, a position of a center among positions of the robots is set as control point, which serves as the center of rotation. The center among the positions of the robots is, for example, a position of the center of gravity.

When setting the center of rotation based on the robots 1 and 2, the controller 4 calculates speeds at which the robots rotate based on the positions of the robots and the set center of rotation, and operates the robots 1 and 2 based on manipulation of the manipulator 3.

When the worked object 5 is held by the robots 1 and 2, the controller 4 determines the control point to be a point inside the worked object 5 or on a surface of the worked object. Accordingly, since the control point at which the robots 1 and 2 operate can be set at a point of the worked object 5, the operator can intuitively perform the operation that moves the worked object 5 by using the robots 1 and 2.

In addition, the controller 4 performs control to operate the robots 1 and 2 based on the manipulation accepted by the single manipulator 3 while changing magnitudes of the holding forces based on contact forces. Accordingly, since the holding forces can be changed depending on the situation, it is possible to easily switch between holding and releasing the worked object 5. In addition, the grasping force can be generated at the point in time when the contact force is detected.

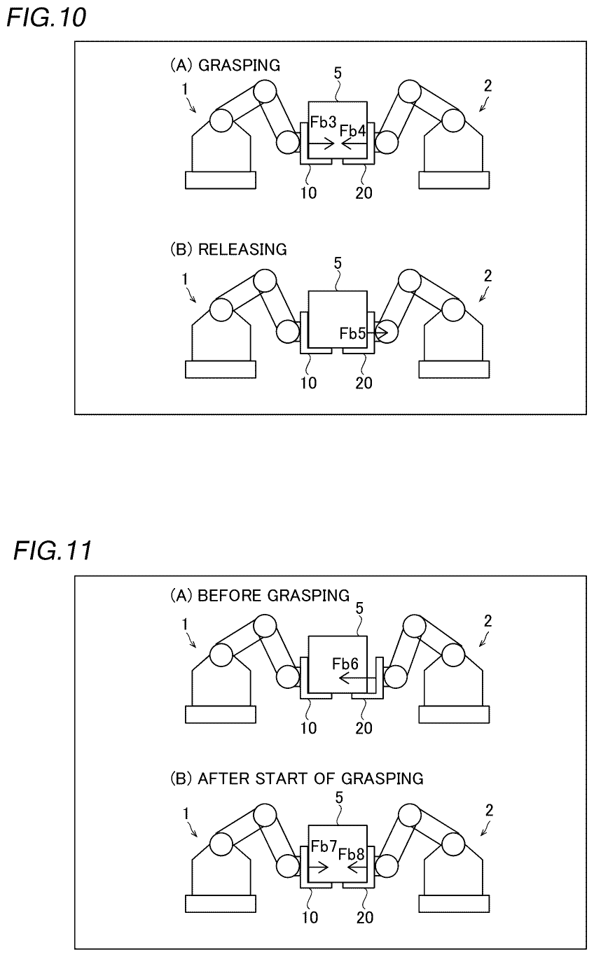

Specifically, as shown in FIG. 10, the controller 4 changes the holding forces depending on whether the worked object 5 is grasped or the worked object 5 is released from grasping. Whether the worked object 5 is grasped or the worked object is released may be input through manipulation on the manipulator 3 by the operator. When the worked object 5 is grasped, the controller 4 applies a holding force Fb3 to the robot 1 and a holding force Fb4 (holding force) to the robot 2. When the worked object 5 is released from the grasping, the controller 4 applies no holding force to the robot 1 and a negative holding force Fb5 (holding force) to the robot 2. In other words, the controller 4 performs calculations to apply a force in a direction opposite to a grasping direction to the robot 2.

Also, as shown in FIG. 11, the controller 4 changes the holding force depending on whether before the worked object 5 is grasped or after the worked object 5 is grasped. The controller 4 sets a larger holding force Fb6 before the worked object 5 is grasped. Accordingly, the robot 2 moves faster. Subsequently, after the worked object 5 is grasped, the controller 4 reduces the holding forces Fb6 and Fb8, while ensuring that forces required for holding the worked object are maintained.

In addition, the controller 4 sets holding directions and magnitudes of the holding forces for the robots. In other words, the holding force is set in accordance with the positions of the robots such that the resultant force of the holding forces applied to the worked object 5 becomes zero.

Also, the controller 4 determines, in accordance with an approaching distance between the robots 1 and 2, repulsive forces acting on the robots in a direction that causes the robots 1 and 2 to separate from each other, and performs control to operate the robots 1 and 2 based on the manipulation through the single manipulator 3. Accordingly, in a case where the robots 1 and 2 are operated in conjunction with each other, since the robots 1 and 2 are prevented from becoming too close to each other, it is possible to prevent interference between the robots 1 and 2.

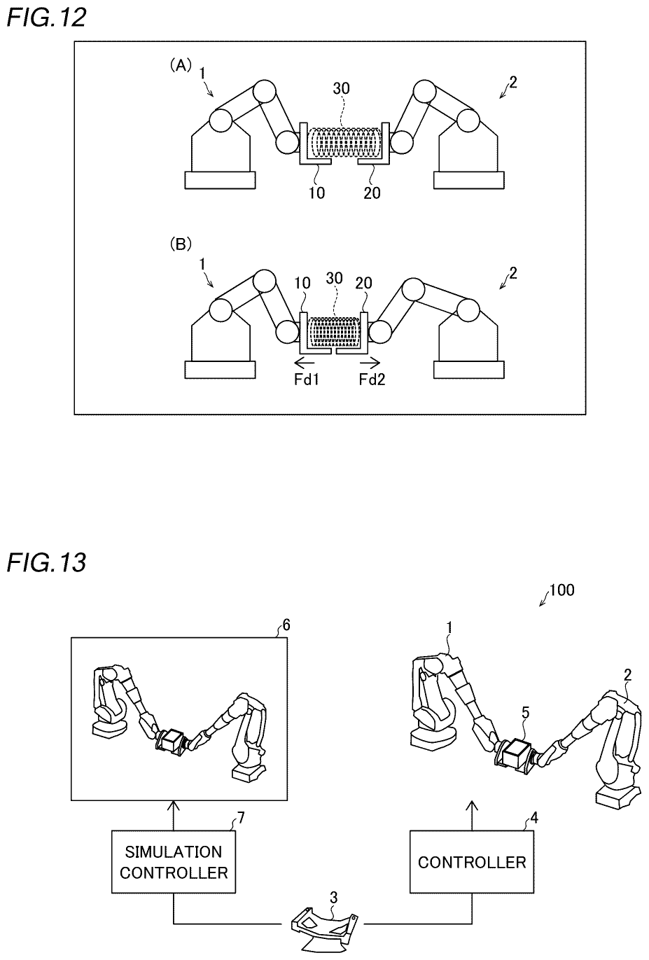

To illustrate, as shown in FIG. 12, a virtual spring 30 is placed between the robots 1 and 2, and when the robots 1 and 2 become close to each other, repulsive forces Fd1 and Fd2 are generated in accordance with a contraction distance of the spring 30. Here, the virtual spring 30 generates a repulsive force when contracting, but does not generate an attractive force when expanding. In other words, both ends of the virtual spring 30 are not fixed to the robots 1 and 2, and only sandwiched between the robots.

Also, the repulsive forces, which act on the robots in the direction that causes the robots 1 and 2 to Separate from each other, are added to the forces (manipulation, contact and grasping forces) before being input to the force control logic 43a and the force control logic 43b (see FIG. 2), and calculation is performed.

Also, a size of the virtual spring 30 may be set depending on the robots. In other words, when the spring 30 is large, even if the distance between the robots is large, the repulsive forces are generated as the robots approach each other. On the other hand, when the spring 30 is small, no repulsive forces are generated unless the distance between the robots becomes small. In addition, a spring constant of the virtual spring 30 may be set depending on the robots.

As shown in FIG. 13, the robot system 100 includes a simulation controller 7 that performs simulation to virtually operate the robot 1 and the robot 2 based on the manipulation through the single manipulator 3. Accordingly, the simulation that virtually operate the robots 1 and 2 can be performed using the single manipulator 3, which manipulates the operation of the robots 1 and 2.

The simulation controller 7 displays simulation images on a display 6 based on manipulation of the manipulator 3. The simulation controller 7 includes a CPU and a memory.

Also, the robot system 100 can switch manipulation of the manipulator 3 between a simulation environment in which the robots 1 and 2 are operated by simulation and an actual environment in which the robots 1 and 2 are actually operated. Accordingly, after a trial manipulation is performed using the manipulator 3 to operate the robot 1 and 2 in a simulation, and the manipulator 3 is used to actually operate the robot 1 and 2, allowing the manipulation to be evaluated. In other words, the robot system 100 can seamlessly switch between the simulation environment and the actual environment. Thus, the results of manipulation performed through trial and error in the simulation environment can be evaluated in the actual environment. In addition, if a trouble occurs in the actual environment, the trouble can be verified in the simulation environment.

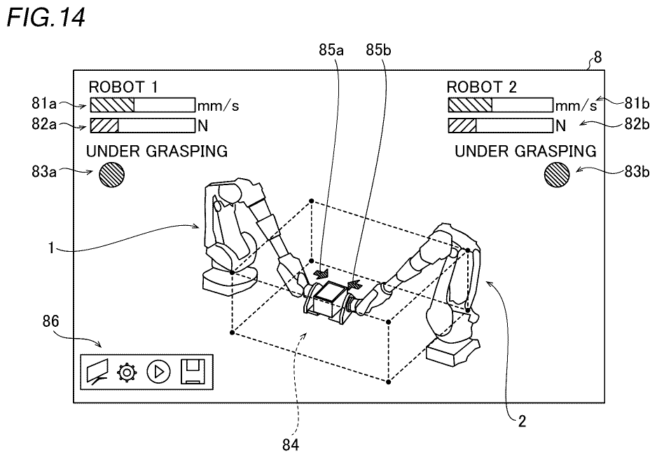

As shown in FIG. 14, the robot system 100 includes an information provider 8 that provides work statuses of the robots 1 and 2. The information provider 8 includes a display. Accordingly, the operator can easily see the work statuses of the robots 1 and 2 provided by the information provider 8.

The information provider 8 provides the work statuses by displaying the work statuses including an operation range of the robot 1 and the robot 2, operating speeds of the robots 1 and 2, the contact forces applied to the robot 1 and the robot 2, and orientations of the distal ends of the robot 1 and the robot 2. Accordingly, the operator can easily see the operation range of the robots 1 and 2, operating speeds of the robots 1 and 2, the contact forces applied to robots 1 and 2, and the orientations of the distal ends of the robots 1 and 2.

Specifically, the information provider 8 displays the operating speed of the robot 1 in an information area 81a and the operating speed of the robot 2 in an information area 81b. Also, the information provider 8 displays the contact force applied to the robot 1 in an information area 82a and the contact force applied to the robot 2 in an information area 82b. Also, the information provider 8 displays information indicating that the robot 1 is grasping in an information area 83a, and information indicating that the robot 2 is grasping in an information area 83b.

Also, the information provider 8 displays the operation range 84 of the robots 1 and 2. Also, the information provider 8 displays an arrow 85a indicating the orientation of the distal end of the robot 1. Also, the information provider 8 displays an arrow 85b indicating the orientation of the distal end of the robot 2. Also, the information provider 8 displays icon buttons in an information area 86.

Also, the information provider 8 displays the work statuses in augmented reality. For example, the information provider 8 includes a head-mounted display and displays information to follow the robots 1 and 2 operating on the display.

### Advantages of the Embodiment

In this embodiment, the following advantages are obtained.

In this embodiment, as described above, the controller 4 is provided to perform control to operate the robots 1 and 2 based on the manipulation accepted by the single manipulator 3. Accordingly, the operator can operate the robots 1 and 2 in conjunction with each other by manipulating the single manipulator 3. Consequently, the operator can perform work by operating the robots 1 and 2 in conjunction with each other through an arbitrary manipulation using the manipulator 3. In addition, since the operator can manipulate the robots 1 and 2 through the single manipulator 3, the operator can easily manipulate the robots as compared with a case where the operator individually manipulates the robots 1 and 2 through separate manipulators. As a result, since an increase in burden on the operator can be prevented, the operator can perform work through the robots 1 and 2 in conjunction with each other.

Also, in this embodiment, as described above, the controller 4 performs control, based on the manipulation by the single manipulator 3, to operate the robot 1 and to operate the robot 2 to follow operation of the robot 1. Accordingly, since the robot 1 can be operated to operate the robot 2 to follow operation of the robot 1 through manipulation by the single manipulator 3, the robot 1 and the robot 2 can be easily operated in conjunction with each other.

Also, in this embodiment, as described above, the controller 4 performs control, based on the manipulation by the single manipulator 3, to operate the robot 1 and to operate the robot 2 based on the moving speed of the robot 1. Accordingly, the robot 2 can be controlled to move in accordance with the moving speed of the robot 1.

Also, in this embodiment, as described above, the controller 4 performs control, when the worked object 5 as a work target is held by using the robot 1 and the robot 2 sandwiching the worked object, to operate the robot 1 and the robot 2 based on the manipulation through the single manipulator 3 to apply predetermined holding forces to the worked object 5. Accordingly, since the holding forces can be constantly applied while the worked object 5 is held by the robots 1 and 2 sandwiching the worked object, the worked object 5 can be reliably held.

Also, in this embodiment, as described above, the controller 4 performs control to operate the robots 1 and 2 based on the manipulation force of the manipulation from the operator accepted by the manipulator 3, the contact forces applied to the robot 1 and the robot 2, and the holding forces holding the worked object 5 by using the robot 1 and the robot 2. Accordingly, the robot 1 and the robot 2 can be moved in conjunction with each other to keep the manipulation force, the contact forces and the holding forces in balance.

Also, in this embodiment, as described above, the controller 4 determines the moving speed of the robot 1 based on the manipulation force of the manipulation from the operator accepted by the manipulator 3, the contact force applied to the robot 1 and the holding force holding the worked object 5, and determines the moving speed of the robot 2 based on the moving speed of the robot 1, the contact force applied to the robot 2 and the holding force holding the worked object 5. Accordingly, control to move the robot 2 in accordance with the movement of the robot 1 can be easily performed based on the moving speed of the robot 1, the contact force applied to the robot 2 and the holding forces.

Also, in this embodiment, as described above, the controller 4 performs control to operate the robot 1 and the robot 2 based on the manipulation accepted by the single manipulator 3 while changing magnitudes of the holding forces based on contact forces. Accordingly, since the holding forces can be changed depending on the situation, it is possible to easily switch between holding and releasing the worked object 5. In addition, the grasping force can be generated at the point in time when the contact force is detected.

Also, in this embodiment, as described above, the controller 4 determines, when the worked object 5 is held by using the robot 1 and the robot 2, the control points at which the robot 1 and the robot 2 operate based on the positions of the robots 1 and 2. Accordingly, since the control point can be set at a point that allows the robot 1 and the robot 2 to easily move the worked object 5 being held by the robots based on the positions of the robots, the operator can intuitively perform the operation that moves the worked object 5 by using the robots 1 and 2.

Also, in this embodiment, as described above, when the worked object 5 is held by the robot 1 and the robot 2, the controller 4 determines the control point to be a point inside the worked object 5 or on a surface of the worked object. Accordingly, since the control point at which the robots 1 and 2 operate can be set at a point of the worked object 5, the operator can intuitively perform the operation that moves the worked object 5 by using the robots 1 and 2.

Also, in this embodiment, as described above, the controller 4 performs control to operate the robot 1 and the robot 2 based on the manipulation through the single manipulator 3 to hold the worked object 5 by using the robot 1 and the robot 2 sandwiching the worked object 5. Accordingly, work can be performed on the worked object 5 while the worked object 5 is held by using the robots 1 and 2 sandwiching the worked object.

Also, in this embodiment, as described above, the controller 4 determines, in accordance with an approaching distance between the robot 1 and the robot 2, repulsive forces acting on the robots in a direction that causes the robots 1 and 2 to separate from each other, and performs control to operate the robot 1 and the robot 2 based on the manipulation through the single manipulator 3. Accordingly, in a case where the robots 1 and 2 are operated in conjunction with each other, since the robots 1 and 2 are prevented from becoming too close to each other, it is possible to prevent interference between the robots 1 and 2.

Also, in this embodiment, as described above, the system can switch between a first mode in which the robot 1 is solely operated by manipulation of the manipulator 3, a second mode in which the robot 2 is solely operated by manipulation of the manipulator 3, and a third mode in which robots 1 and 2 are operated in conjunction with each other by manipulation of the manipulator 3. Accordingly, each of the robots 1 and 2 can be solely operated to be positioned at a desired position, and the robots 1 and 2 can be operated in conjunction with each other.

Also, in this embodiment, as described above, the simulation controller 4 is further provided to perform simulation to virtually operate the robot 1 and the robot 2 based on the manipulation through the single manipulator 3. Accordingly, the simulation that virtually operate the robots 1 and 2 can be performed using the single manipulator 3, which manipulates the operation of the robots 1 and 2.

Also, in this embodiment, as described above, the system can switch manipulation of the manipulator 3 between a simulation environment in which the robot 1 and the robot 2 are operated by simulation and an actual environment in which the robots 1 and 2 are actually operated. Accordingly, the robot system 100 can seamlessly switch between the simulation environment and the actual environment.

Also, in this embodiment, as described above, the information provider is further provided to provide a work status(es) of the robot 1 and the robot 2, and the information provider includes at least one of the display, the manipulator 3 or a peripheral device. Accordingly, the operator can easily see the work status(es) of the robots 1 and 2 provided by the information provider 8.

Also, in this embodiment, as described above, the information provider provides the work status(es) by displaying the work statuses including at least one of an operation range of the robot 1 and the robot 2, operating speeds of the robots 1 and 2, the contact forces applied to the robot 1 and the robot 2, or orientations of the distal ends of the robot 1 and the robot 2. Accordingly, the operator can easily recognize the work status(es) of the robots 1 and 2.

### Modified Embodiments

Note that the embodiment disclosed this time must be considered as illustrative in all points and not restrictive. The scope of the present disclosure is not shown by the above description of the embodiments but by the scope of claims for patent, and all modifications (modified embodiments) within the meaning and scope equivalent to the scope of claims for patent are further included.

For example, while the example in which the present disclosure is applied to an industrial or medical robot has been shown in the aforementioned embodiment, the present disclosure is not limited to this. For example, the present disclosure may be applied to a humanoid robot.

While the example in which the robot includes a vertical multi-joint arm with six joints has been shown in the aforementioned embodiment, the present disclosure is not limited to this. For example, the robot may include a vertical multi-joint with not greater than five or not smaller than seven axes. Also, a horizontal multi-joint robot may be used.

While the example in which two robots are provided in the robot system has been shown in the aforementioned embodiment, the present disclosure is not limited to this. For example, three or more robots may be provided in the robot system. In this case, the three or more robots may be operated by the single manipulator. In this case, the third and subsequent robots may be operated at moving speeds calculated based on operation of the first robot.

Also, while the example in which the information provider includes a display has been shown in the aforementioned embodiment, the present disclosure is not limited to this. For example, the information provider may include at least one of the display, the manipulator or a peripheral device.

Also, while the example in which the information provider provides the work statuses by displaying an operation range of the first robot and the second robot, operating speeds of the first robot and the second robot, contact forces applied to the first robot and the second robot, and orientations of distal ends of the first robot and the second robot has been shown in the aforementioned embodiment, the present disclosure is not limited to this. The information provider may provide a work status(es) by displaying at least one of an operation range of the first robot and the second robot, operating speeds of the first robot and the second robot, contact forces applied to the first robot and the second robot, or orientations of distal ends of the first robot and the second robot.

Also, while the example in which the first robot and the second robot are operated by the common controller has been shown in the aforementioned embodiment, the present disclosure is not limited to this. For example, the controllers and the manipulators may be provided for the first and second robots to operate the first robot and the second robot independently each other, and if necessary, and the first robot and the second robot can be operated in conjunction with each other by collaboration control performed by each controller based on manipulation using common one of the manipulators. In this case, signals from the manipulator of the first robot can be transmitted to the controller of the second robot to perform the collaboration control of the second robot. At that time, a signal to switch to collaboration control can be issued from the manipulator of the second robot, the signal to switch to collaboration control can be issued from the manipulator of the first robot, or a command for collaboration control can be executed by a higher-level system.

Functions of elements disclosed in this specification can be realized by a circuit or processing circuit including a general-purpose processor, a dedicated processor, an integrated circuit, ASIC (Application Specific Integrated Circuits), a conventional circuit and/or combination of them configured or programmed to realize the functions disclosed. A processor is considered a processing circuit or circuits because it contains transistors and other circuitry. In the present disclosure, a circuit, unit, or means is hardware that performs an enumerated function or is hardware programmed to perform an enumerated function. The hardware may be the hardware disclosed herein or any other known hardware that is programmed or configured to perform the enumerated functions. If the hardware is a processor, which is considered a type of circuit, the circuit, means, or unit is a combination of hardware and software, and software is used to configure the hardware and/or processor.

### Modes

It is understood by those skilled in the art that the exemplary embodiments described above are specific examples of the following aspects.

### (Mode Item 1)

A robot system includes a first robot; a second robot that performs work in cooperation with the first robot; a single manipulator that accepts manipulation from an operator to manipulate the first robot and the second robot; and a controller that performs control to operate the first robot and the second robot based on the manipulation accepted by the single manipulator.

### (Mode Item 2)

In the robot system according to mode item 1, the controller performs control, based on the manipulation by the single manipulator, to operate the first robot and to operate the second robot to follow operation of the first robot.

### (Mode Item 3)

In the robot system according to mode item 2, the controller performs control, based on the manipulation by the single manipulator, to operate the first robot and to operate the second robot based on a moving speed of the first robot.

### (Mode Item 4)

In the robot system according to any of mode items 1 to 3, the controller performs control, when a worked object as a work target is held by using the first robot and the second robot sandwiching the worked object, to operate the first robot and the second robot based on the manipulation through the single manipulator to apply predetermined holding forces to the worked object.

### (Mode Item 5)

In the robot system according to mode item 4, the controller performs control to operate the first robot and the second robot based on a manipulation force of the manipulation from the operator accepted by the manipulator, contact forces applied to the first robot and the second robot, and holding forces holding the worked object by using the first robot and the second robot.

### (Mode Item 6)

In the robot system according to mode item 5, the controller determines a moving speed of the first robot based on the manipulation force of the manipulation from the operator accepted by the manipulator, the contact force applied to the first robot and the holding force holding the worked object, and determines a moving speed of the second robot based on the moving speed of the first robot, the contact force applied to the second robot, and the holding force holding the worked object.

### (Mode Item 7)

In the robot system according to any of mode items 4 to 6, the controller performs control to operate the first robot and the second robot based on the manipulation accepted by the single manipulator while changing magnitudes of the holding forces based on contact forces.

### (Mode Item 8)

In the robot system according to any of mode items 4 to 7, the controller determines, when the worked object is held by using the first robot and the second robot, a control point at which the first robot and the second robot operate based on a position of the first robot and a position of the second robot.

### (Mode Item 9)

In the robot system of mode item 8, the controller determines, when the worked object is held by using the first robot and the second robot, the control point to be a point inside the worked object or on a surface of the worked object.

### (Mode Item 10)

In the robot system according to any of mode items 4 to 9, the controller performs control to operate the first robot and the second robot based on the manipulation through the single manipulator to hold the worked object by using the first robot and the second robot sandwiching the worked object.

### (Mode Item 11)

In the robot system according to mode item 5 or 6, the controller determines, in accordance with an approaching distance between the first robot and the second robot, repulsive forces acting on the first robot and the second robot in a direction that causes the first robot and the second robot to separate from each other, and performs control to operate the first robot and the second robot based on the manipulation through the single manipulator.

### (Mode Item 12)

In the robot system according to any of mode items 1 to 11, the system switches between a first mode in which the first robot is solely operated by manipulation through the manipulator, a second mode in which the second robot is solely operated by manipulation through the manipulator, and a third mode in which the first robot and the second robot are operated in conjunction with each other by manipulation through the manipulator.

### (Mode Item 13)

The robot system according to any of mode items 1 to 12 further includes a simulation controller that performs simulation to virtually operate the first robot and the second robot based on the manipulation through the single manipulator.

### (Mode Item 14)

In the robot system according to mode item 13, manipulation by the manipulator is switched between a simulation environment in which the first robot and the second robot are operated by simulation and an actual environment in which the first robot and the second robot are actually operated,

### (Mode Item 15)

In the robot system according to any of mode items 1 to 14, an information provider that provides a work status(es) of the first robot and the second robot, the information provider includes at least one of a display, the manipulator or a peripheral device.

### (Mode Item 16)

In the robot system according to mode item 15, the information provider provides the work status(es) by displaying at least one of an operation range of the first robot and the second robot, operating speeds of the first robot and the second robot, contact forces applied to the first robot and the second robot, or orientations of distal ends of the first robot and the second robot.

### DESCRIPTION OF REFERENCE NUMERALS

1; robot (first robot)
2; robot (second robot)
3; manipulator
4; controller
5; worked object
6; display
7; simulation controller
8; information provider
100; robot system

1. A robot system comprising:
a first robot;
a second robot that performs work in cooperation with the first robot;
a single manipulator that accepts manipulation from an operator to manipulate the first robot and the second robot; and
a controller that performs control to operate the first robot and the second robot based on the manipulation accepted by the single manipulator.

2. The robot system according to claim 1, wherein the controller performs control, based on the manipulation by the single manipulator, to operate the first robot and to operate the second robot to follow operation of the first robot.

3. The robot system according to claim 2, wherein the controller performs control, based on the manipulation by the single manipulator, to operate the first robot and to operate the second robot based on a moving speed of the first robot.

4. The robot system according to claim 1, wherein the controller performs control, when a worked object as a work target is held by using the first robot and the second robot sandwiching the worked object, to operate the first robot and the second robot based on the manipulation through the single manipulator to apply a predetermined holding force(s) to the worked object.

5. The robot system according to claim 4, wherein the controller performs control to operate the first robot and the second robot based on a manipulation force of the manipulation from the operator accepted by the manipulator, a contact forces applied to the first robot and the second robot, and a holding force(s) holding the worked object by using the first robot and the second robot.

6. The robot system according to claim 5, wherein the controller determines a moving speed of the first robot based on the manipulation force of the manipulation from the operator accepted by the manipulator, the contact force applied to the first robot and the holding force(s) holding the worked object, and determines a moving speed of the second robot based on the moving speed of the first robot, the contact force applied to the second robot, and the holding force(s) holding the worked object.

7. The robot system according to claim 4, wherein the controller performs control to operate the first robot and the second robot based on the manipulation accepted by the single manipulator while changing a magnitude(s) of the holding force(s) based on contact forces.

8. The robot system according to claim 4, wherein the controller determines, when the worked object is held by using the first robot and the second robot, a control point at which the first robot and the second robot operate based on a position of the first robot and a position of the second robot.

9. The robot system of claim 8, wherein the controller determines, when the worked object is held by using the first robot and the second robot, the control point to be a point inside the worked object or on a surface of the worked object.

10. The robot system according to claim 4, wherein the controller performs control to operate the first robot and the second robot based on the manipulation through the single manipulator to hold the worked object by using the first robot and the second robot sandwiching the worked object.

11. The robot system according to claim 5, wherein the controller determines, in accordance with an approaching distance between the first robot and the second robot, repulsive forces acting on the first robot and the second robot in a direction that causes the first robot and the second robot to separate from each other, and performs control to operate the first robot and the second robot based on the manipulation through the single manipulator.

12. The robot system according to claim 1, wherein the system switches between a first mode in which the first robot is solely operated by manipulation through the manipulator, a second mode in which the second robot is solely operated by manipulation through the manipulator, and a third mode in which the first robot and the second robot are operated in conjunction with each other by manipulation through the manipulator.

13. The robot system according to claim 1 further comprising a simulation controller that performs simulation to virtually operate the first robot and the second robot based on the manipulation through the single manipulator.

14. The robot system according to claim 13, wherein manipulation by the manipulator is switched between a simulation environment in which the first robot and the second robot are operated by simulation and an actual environment in which the first robot and the second robot are actually operated,

15. The robot system according to claim 1, further comprising an information provider that provides a work status(es) of the first robot and the second robot, wherein
the information provider includes at least one of a display, the manipulator or a peripheral device.

16. The robot system according to claim 15, wherein the information provider provides the work status(es) by displaying at least one of an operation range of the first robot and the second robot, operating speeds of the first robot and the second robot, contact forces applied to the first robot and the second robot, or orientations of distal ends of the first robot and the second robot.
